(19) United States
(12) Patent Application Publication
(10) Pub. No.: US 2006/0238287 A1
(43) Pub. Date: Oct. 26, 2006

(54) Explosion proof door holder

(75) Inventor: Andrea Furia, Downey, CA (US)

Correspondence Address: AVERILL & VARN, 8244 PAINTER AVE., WHITTIER, CA, 90602, US

(73) Assignee: RSG/Aames Security, Inc.

(21) Appl. No.: 11/318,681

(22) Filed: Dec. 27, 2005

Related U.S. Application Data
(63) Continuation-in-part of application No. 11/013,037, filed on Dec. 11, 2004.

(51) Int. Cl. H01F 7/20

(52) U.S. Cl. 335/285

(57) ABSTRACT

An explosion proof electromagnetic door holder includes an explosion cover to protect internal door holder components. The explosion proof electromagnetic door holder comprises a wall box, the explosion cover attached to the wall box, a coil assembly attached to the explosion cover, and a face plate over the explosion cover. The explosion cover protects the coil assembly in the event of an explosion. The coil assembly includes a bobbin containing a wire coil. A sealant, preferably epoxy, may be used to cover the face of the bobbin to prevent moisture from entering the coil assembly. A coil seal may also be incorporated between a cover passage in the explosion cover and the coil assembly to resist the entry of moisture into the wall box. The resulting explosion proof electromagnetic door holder resists damage to the coil assembly in the event of an explosion.

The present application is a Continuation in Part of U.S. patent application Ser. No. 11/013,037, filed Dec. 11, 2004, which application is incorporated herein by reference.

### BACKGROUND OF THE INVENTION

The present invention relates to explosion proof electrical devices and in particular to explosion proof electromagnetic door holders.

Electromagnetic door holders are designed to hold fire doors open for convenient access through busy door ways, and to release the fire doors when a signal is received, generally because an alarm is triggered. Such electromagnetic door holders are often used in hazardous-area environments, for example, in chemical processing facilities, nuclear power plants, offshore gas and fuel platforms, and in the maritime industry in general. The electromagnetic door holders may be used on fire dampers, fire doors, safety doors and the like.

Flammable materials are present in many of these hazardous-area environments and a leak or spill may give rise to an explosive atmosphere. The areas having a potential for an explosive atmosphere are known as ‘hazardous areas’ and the materials which are commonly present include crude oil and its derivatives, process gases, alcohols, metal dusts, carbon dust, flour, starch, grain, and fibers. To protect both personnel and facilities, precautions must be taken to ensure that such explosive atmospheres are not ignited, and if ignited, the spread of any resulting fire is limited as much as possible. Containment of explosive atmospheres and/or fires resulting from explosive atmospheres is therefore an important aspect of protecting both personnel and facility. Such containment is generally achieved by closing doors between compartments and/or rooms, and electromagnetic door holders are a common means for closing doors.

Unfortunately, the electromagnetic door holders may themselves be damaged in an initial explosion. As a result, the doors may not be closed, and fires, hazardous fumes, etc. may quickly spread through a facility, causing further explosions, files, and toxic environments.

### BRIEF SUMMARY OF THE INVENTION

The present invention addresses the above and other needs by providing an explosion proof electromagnetic door holder which includes an explosion cover to protect internal door holder components. The explosion proof electromagnetic door holder comprises a wall box, the explosion cover attached to the wall box, a coil assembly attached to the explosion cover, and a face plate over the explosion cover. The explosion cover protects the coil assembly in the event of an explosion. The coil assembly includes a bobbin containing a wire coil. A sealant, preferably epoxy, may be used to cover the face of the bobbin to prevent moisture from entering the coil assembly. A coil seal may also be incorporated between a cover passage in the explosion cover and the coil assembly to resist the entry of moisture into the wall box. The resulting explosion proof electromagnetic door holder resists damage to the coil assembly in the event of an explosion.

In accordance with one aspect of the invention, there is provided an explosion resistant electromagnetic door holder. The explosion resistant electromagnetic door holder comprises a wall box, an explosion cover, a coil assembly, and a face plate. The wall box is configured for mounting to a wall and has at least one conduit opening. The explosion cover attaches to the wall box and provides resistance to an explosion. The coil assembly includes circuit components, which circuit components reside behind the explosion cover. The face plate resides over the explosion cover.

In accordance with another aspect of the invention, there is provided an explosion and moisture resistant electromagnetic door holder. The moisture resistant electromagnetic door holder comprises a wall box, an explosion cover, and a coil assembly. The wall box is configured for mounting on a wall and has at least one conduit opening. The explosion cover is attached to the wall box and provides resistance to an explosion. A moisture resistant seal resides between the explosion cover and the wall box. The coil assembly includes circuit components which reside behind the explosion cover.

In accordance with yet another aspect of the invention, there is provided an explosion cover which may be used with an existing wall mounted box and cover plate to create an explosion proof door holder. The explosion cover attaches to the existing wall box, and the existing face plate attaches to the explosion cover.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a door held open by a wall mounted explosion resistant electromagnetic door holder.

FIG. 2 shows detailed view of the wall mounted explosion resistant door holder according to the present invention.

FIG. 3 is an exploded front perspective view of the explosion resistant door holder.

FIG. 4 is an exploded rear perspective view of the explosion resistant door holder.

FIG. 5A is a front view of a wall box according to the present invention.

FIG. 5B is a side view of the wall box according to the present invention.

FIG. 5C is a rear view of the wall box according to the present invention.

FIG. 5D is a top view of the wall box according to the present invention.

FIG. 6A is a front view of an explosion cover according to the present invention.

FIG. 6B is a rear view of the explosion cover according to the present invention.

FIG. 7 is a cross-sectional view of the explosion cover taken along line 7-7 of FIG. 6A.

FIG. 8A is a front view of a face plate according to the present invention.

FIG. 8B is a rear view of the face plate according to the present invention.

FIG. 8C is a top view of the face plate according to the present invention.

FIG. 9 is a cross-sectional view of the face plate taken along line 9-9 of FIG. 8A.

FIG. 10A is a side view of the coil assembly separated from the explosion cover and face plate.

FIG. 10B is a side view of the coil assembly attached to the explosion cover and face plate.

FIG. 10C is a top view of the coil assembly attached to the explosion cover and face plate.

FIG. 11 is a cross-sectional side view of the coil assembly attached to the explosion cover and face plate taken along line 11-11 of FIG. 10C

FIG. 12A is a side view of the coil assembly.

FIG. 12B is a front view of the coil assembly.

FIG. 13 is a cross-sectional view of the coil assembly taken along line 13-13 of FIG. 12B.

FIG. 14 is an exploded perspective view of the coil assembly.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

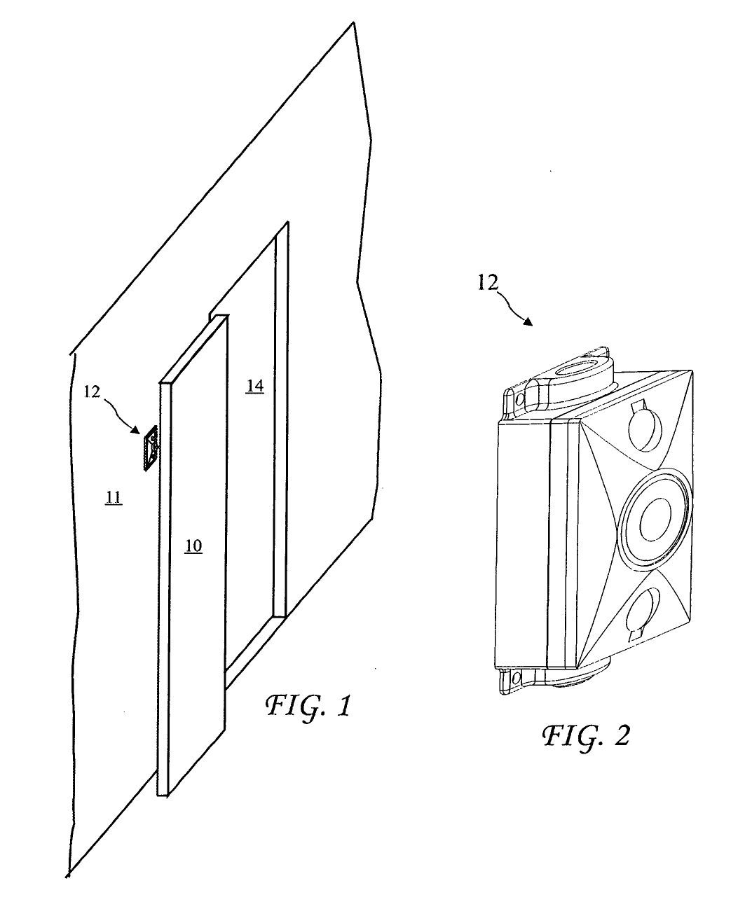

A door 10 held open by an explosion resistant electromagnetic door holder 12 mounted to a wall 11 is shown in FIG. 1, and a detailed view of the explosion resistant electromagnetic door holder 12 is shown in FIG. 2. The electromagnetic door holder 12 holds the door 10 open as long as power is provided to the electromagnetic door holder 12. In the case of fire, or some other triggering event, power is removed, and the electromagnetic door holder 12 releases the door 10 to close in the doorway 14. The wall 11 may be an exterior wall and the door 10 may open to the outside or the inside, and as a result, the electromagnetic door holder 12 may be exposed to rain, sprinklers, or other moisture sources.

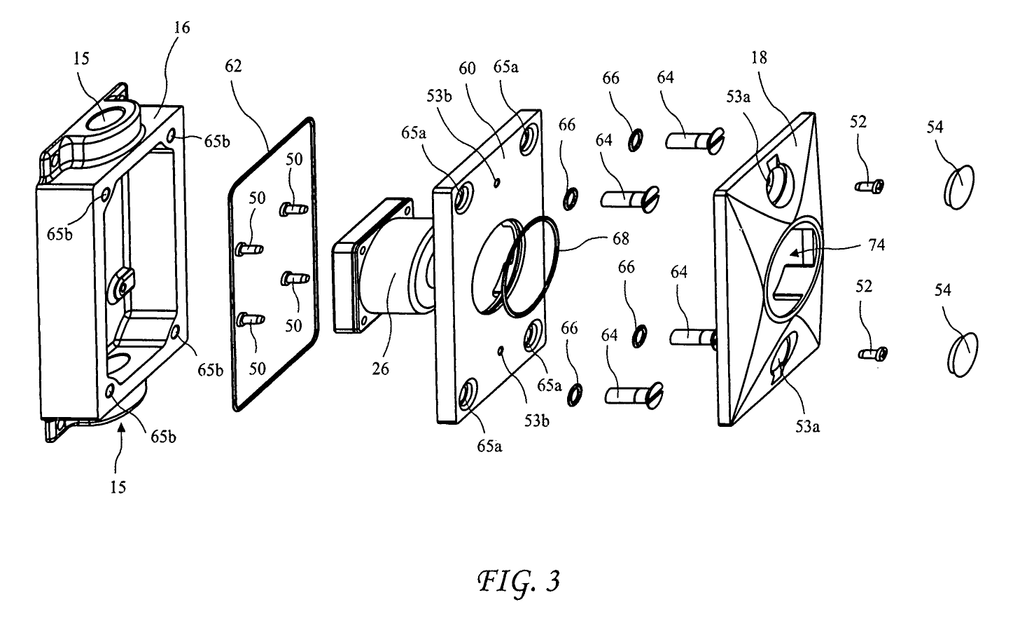

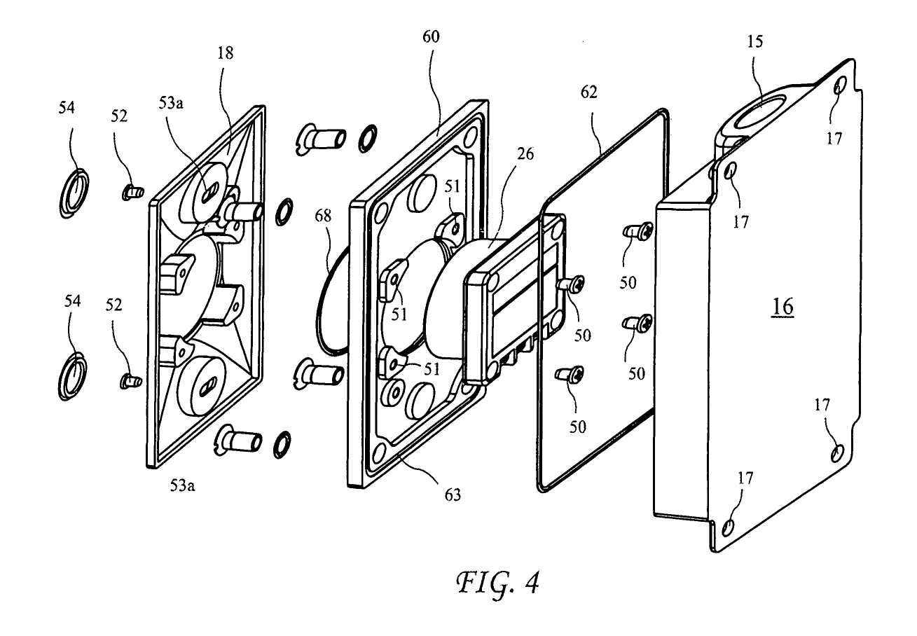

An exploded front view of the explosion resistant electromagnetic door holder 12 is shown in FIG. 3. The explosion resistant electromagnetic door holder 12 comprises a wall box 16, an explosion cover 60, a coil assembly 26, and a face plate 18. The wall box 16 includes a conduit opening 15 to allow conduit to be connected to the wall box 16 to carry and protect electrical wiring running to or from the wall box 16. The explosion cover 60 protects the interior of the wall box 16 from explosions and is attached to the wall box 16 by four explosion cover screws 64 which pass though screw passages 65a in the explosion cover 60 and into screw receptacle 65b in the wall box 16. Screw O-Rings 66 reside between the screws 64 and the explosion cover 60 to resist the entry of moisture into the wall box 16. The screws are preferably stainless steel screws and the O-Rings may be made from an acid resistant material. An explosion cover seal 62 preferably resides between the explosion cover 60 and the wall box 16, which explosion cover seal 62 is preferably an explosion cover O-Ring which at least partially resides in a cover O-Ring groove 63 (see FIG. 4). The seals resist the entry of corrosive and other fumes into the wall box 16.

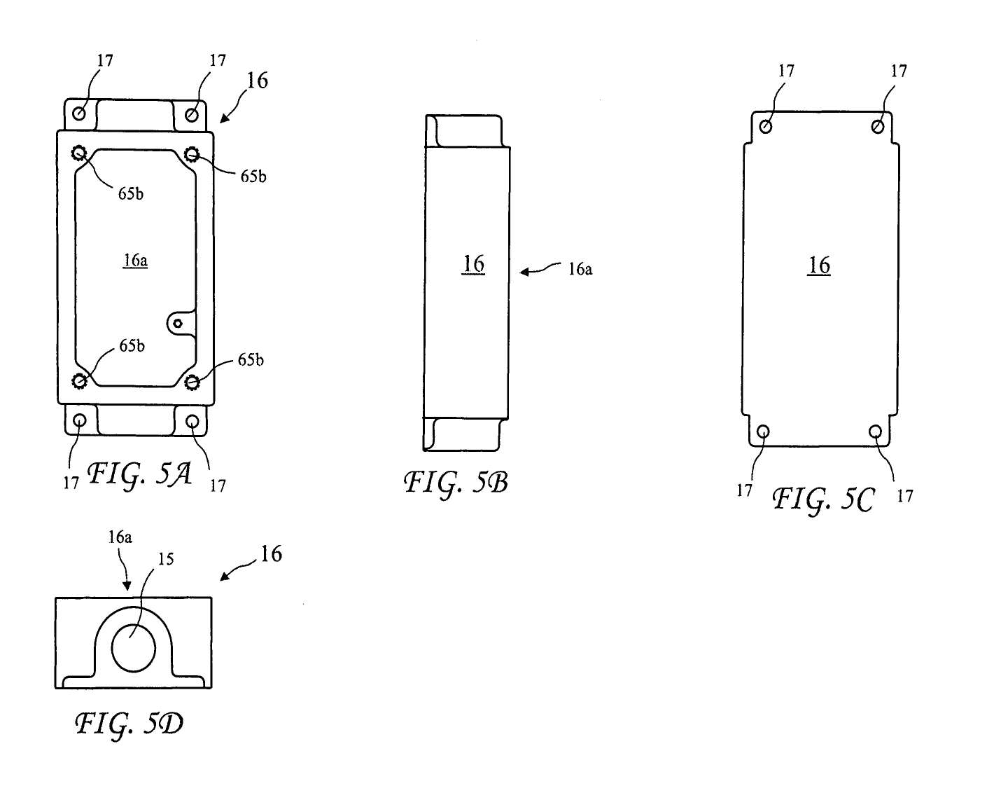

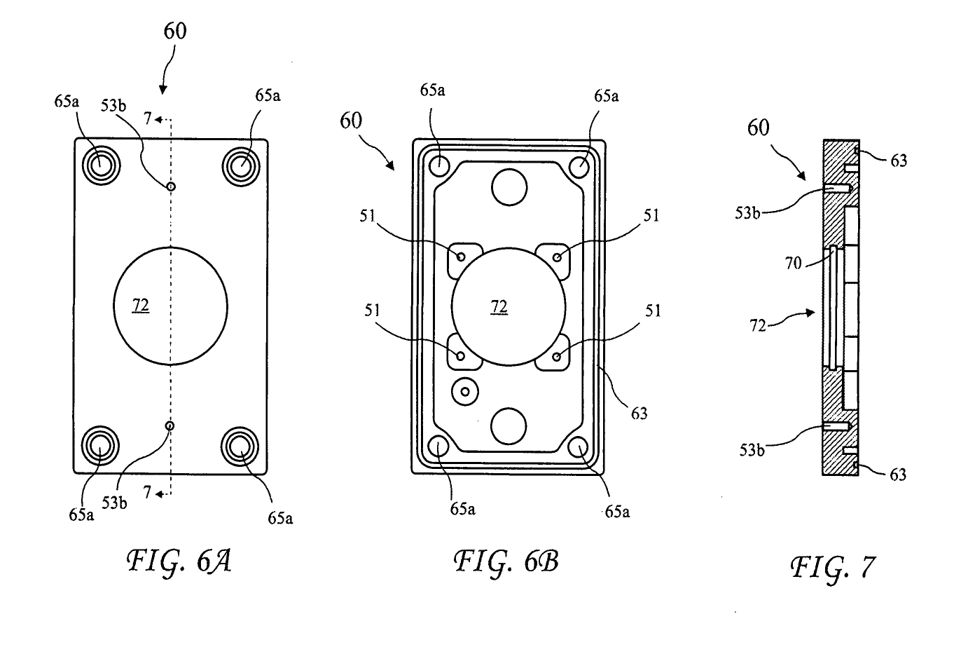

The coil assembly 26 is attached to a rear face of the explosion cover 60 by four coil assembly screws 50. Thus, a coil circuit 32 (see FIG. 13) resides behind and protected by the explosion cover 60. The coil assembly 26 includes a coil housing 28 (see FIG. 14) extending through a cover passage 72 (see FIGS. 6A, 6B, and 7) in the explosion cover 60. A coil seal 68 resides between the coil assembly 26 and the explosion cover 60. The coil seal 68 resists the entry of moisture into the wall box 16. The coil seal 68 is preferably a coil O-Ring which preferably partly resides in a coil O-Ring groove 70 (see FIG. 7) in the coil passage 72, but may be a gasket, a mastic, a silicon sealer, or any suitable moisture sealing material. The O-Ring may alternatively or additionally reside partially in an O-Ring groove on the exterior of the coil housing 28.

The face plate 18 is attached to the explosion cover 60 by two face plate screws 52 passing through face plate screw passages 53a in the face plate 18 and into face plate screw receptacles 53b in the explosion cover 60. Screw covers 54 reside over the screws 52.

An exploded rear view of the explosion resistant electromagnetic door holder 12 is shown in FIG. 4. The cover O-Ring groove 63 resides on a rear face of the explosion cover 60. The coil assembly 26 is attached to the explosion cover 60 through cooperation of the coil assembly screws 50 with the coil screw receptacles 51, and the wall box 16 includes wall box mounting holes 17 for attaching the wall box 16 to the wall 11 (See FIG. 1).

A front view of the wall box 16 is shown in FIG. 5A, a side view of the wall box 16 is shown in FIG. 5B, a rear view of the wall box 16 is shown in FIG. 5C, and a top view of the wall box 16 is shown in FIG. 5D.

A front view of the explosion cover 60 is shown in FIG. 6A, a rear view in FIG. 6B, and a cross-sectional view taken along line 7-7 of FIG. 6A is shown in FIG. 7. The cover passage 72 includes the coil O-Ring groove 70 for cooperating with the coil O-Ring 68 (see FIGS. 3 and 4). The explosion cover 60 is preferably made from aluminum and is preferably at least approximately 0.5 inches thick.

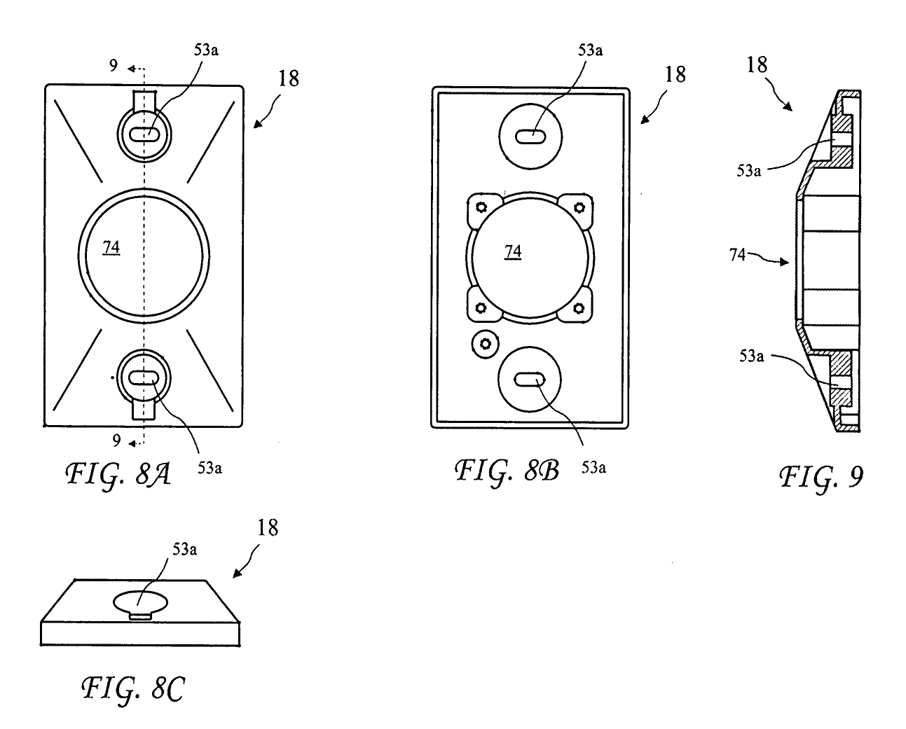

A front view of a face plate 18 is shown in FIG. 8A, a rear view of the face plate 18 is shown in FIG. 8B, a top view of the face plate 18 is shown in FIG. 8C, and a cross-sectional view of the face plate 18 taken along line 9-9 of FIG. 8A is shown in FIG. 9.

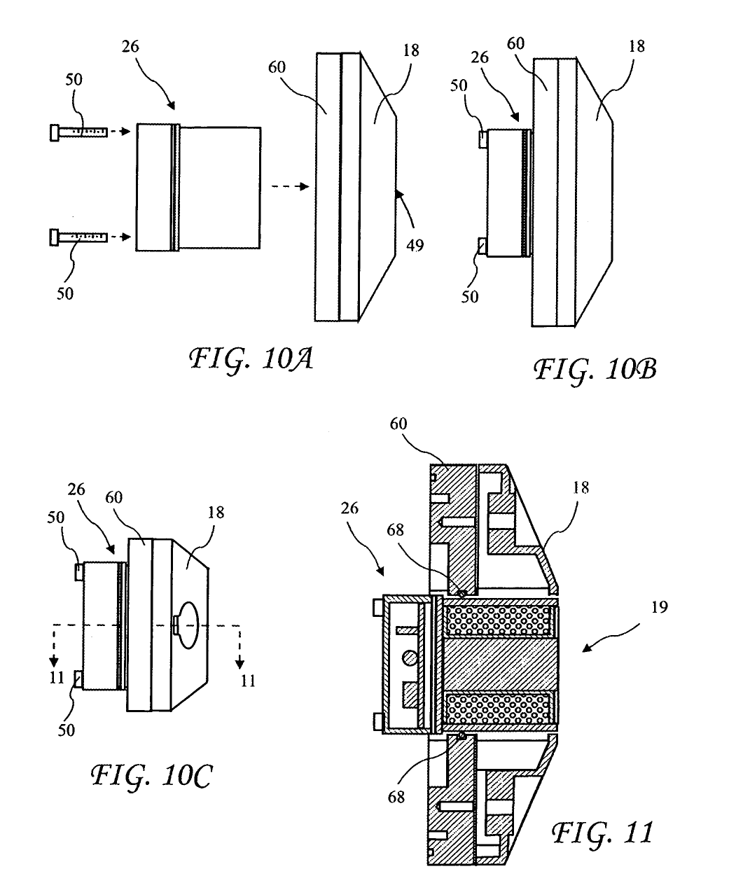

The face plate 18, explosion cover 60, and the coil assembly 26 are shown in a side view prior to assembly in FIG. 10A. The assembled face plate 18, explosion cover 60, and the coil assembly 26 are shown in side view in FIG. 10B and in top view in FIG. 10C. A cross-sectional view of the assembled face plate 18, explosion cover, and coil assembly 26 taken along line 11-11 of

FIG. 10C is shown in FIG. 11. The coil assembly 26 extends through the cover passage 72 and face passage 74 (see FIGS. 6A, 6B, and 7).

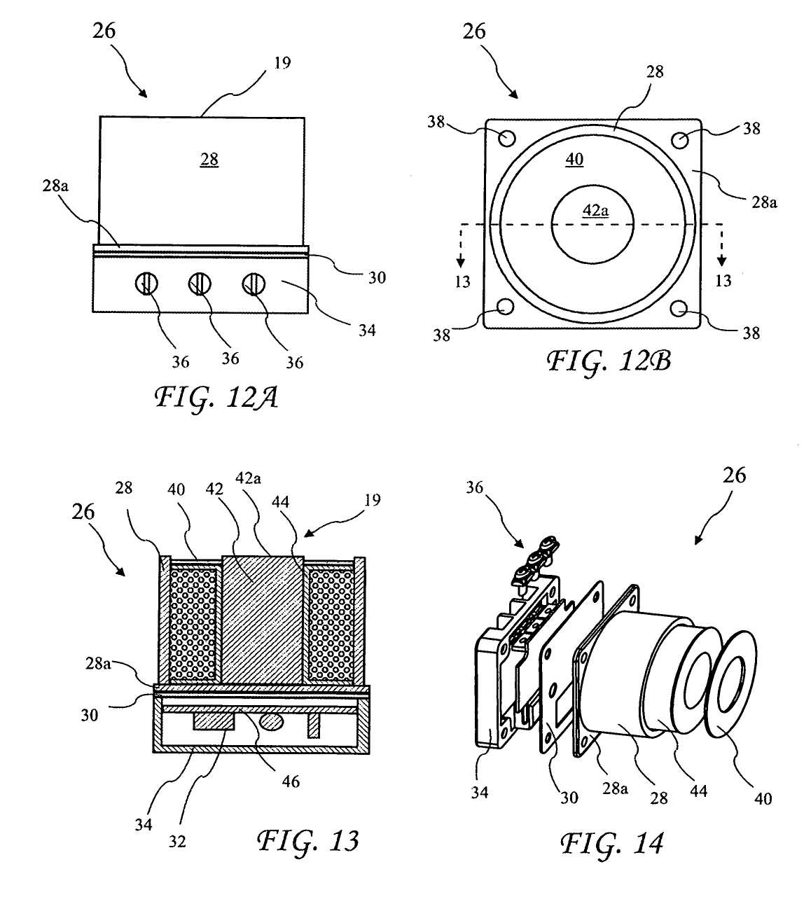

A side view of the coil assembly 26 according to the present invention is shown in FIG. 12A and a top view of the coil assembly 26 is shown in FIG. 12B. The coil assembly 26 includes three electrical terminals 36 for connecting electrical wiring to the coil assembly 26. The coil assembly preferably receives a power signal between 12 and 24 Volts Direct Current (VDC) or between 24 and 120 Volts Alternating Current (VAC) to energize the coil. Four coil screw passages 38 are provided in the base portion 28a for attaching the coil assembly 26 to the explosion cover 60. A coil insulator 30 resides between the coil housing 28 and a circuit housing 34. The three electrical terminals 36 preferably reside on the exterior of the circuit housing 34.

A cross-sectional view of the coil assembly taken along ling 13-13 of FIG. 12B is shown in FIG. 13. The coil face 19 includes a coil seal 40 residing over a bobbin 44, and an exposed core face 42a of a coil core 42, wherein the seal 40 preferably resides in a gap between the exposed core face 42a and the coil housing 28. The seal 40 resists the entry of moisture into the coil assembly 26, and preferably prevents the entry of moisture into the coil assembly 26. The seal 40 is preferably an epoxy seal. An epoxy provides excellent environmental and chemical resistance, and acts as an electrical insulator. A Printed Circuit (PC) board 46 resides in the circuit housing 34.

An exploded perspective view of the coil assembly 26 is shown in FIG. 14. The coil assembly 26 comprises a circuit housing 34 containing a circuit, terminals 36 for making electrical connections with the circuit, a coil insulator 30, a coil housing 28 having a base portion (or flange) 28a, a bobbin 44 residing in the coil housing 28, and a coil seal 40.

While the invention herein disclosed has been described by means of specific embodiments and applications thereof, numerous modifications and variations could be made thereto by those skilled in the art without departing from the scope of the invention set forth in the claims.

I claim:

1. An explosion resistant electromagnetic door holder comprising:
a wall box;
an explosion cover attached to the wall box, the explosion cover providing resistance to an explosion; and
a coil assembly, at least a portion of which is protected by the explosion cover.

2. The explosion resistant electromagnetic door holder of claim 1, wherein:
the wall box includes a wall box mouth; and
the explosion cover comprises a protective cover over the wall box mouth.

3. The explosion resistant electromagnetic door holder of claim 2, wherein the coil assembly is mounted to an inner face of the explosion cover.

4. The explosion resistant electromagnetic door holder of claim 3, wherein the coil assembly includes a coil circuit, and wherein the coil circuit resides behind the explosion cover.

5. The explosion resistant electromagnetic door holder of claim 4, wherein:
the explosion cover includes a cover passage;
the coil assembly includes a bobbin in a coil housing; and
the coil housing passes through the cover passage.

6. The explosion resistant electromagnetic door holder of claim 5, wherein a moisture resistant coil seal resides between the cover passage and the coil housing to resist the entry of moisture into the wall box.

7. The explosion resistant electromagnetic door holder of claim 6, wherein:
the coil seal comprises a coil O-Ring;
the coil passage includes a coil O-Ring groove; and
the coil O-Ring at least partially resides in the coil O-Ring groove.

8. The explosion resistant electromagnetic door holder of claim 1, wherein:
the coil assembly includes a coil core and a coil housing;
a bobbin resides between the coil core and the coil housing; and
a sealing material resides in a gap between an exposed core face of the coil core and the coil housing to resist the entry of moisture into the coil assembly.

9. The explosion resistant electromagnetic door holder of claim 1, wherein an explosion cover seal resides between the explosion cover and the wall box to resist the entry of moisture into the wall box.

10. The explosion resistant electromagnetic door holder of claim 9, wherein:
the explosion cover seal comprises a cover O-Ring;
the wall box includes a cover O-Ring groove; and
the cover O-Ring at least partially resides in the cover O-Ring groove.

11. The explosion resistant electromagnetic door holder of claim 1, wherein the wall box includes at least one conduit opening for connecting electrical conduit to the wall box for carrying electrical wiring to the wall box.

12. The explosion resistant electromagnetic door holder of claim 1, further including a face plate over the explosion cover.

13. An explosion resistant electromagnetic door holder comprising:
a wall box configured for mounting to a wall and having at least one conduit opening;
an explosion cover attached to the wall box, the explosion cover providing resistance to an explosion;
a coil assembly including circuit components, the circuit components residing behind the explosion cover; and
a face plate residing over the explosion cover.

14. An explosion and moisture resistant electromagnetic door holder comprising:
a wall box configured for mounting on a wall and having at least one conduit opening;
an explosion cover attached to the wall box, the explosion cover providing resistance to an explosion;
a moisture resistant seal between the explosion cover and the wall box; and
a coil assembly including circuit components, the circuit components residing behind the explosion cover.
